(19) United States
(12) Patent Application Publication
(10) Pub. No.: US 2015/0104963 A1
(43) Pub. Date: Apr. 16, 2015

(54) CONNECTOR

(71) Applicant: Yazaki Corporation, Tokyo (JP)

(72) Inventor: Masayuki SAITOH, Makinohara-shi (JP)

(73) Assignee: Yazaki Corporation, Tokyo (JP)

(21) Appl. No.: 14/575,191

(22) Filed: Dec. 18, 2014

Related U.S. Application Data
(63) Continuation of application No. PCT/JP2013/070076, filed on Jul. 24, 2013.

(30) Foreign Application Priority Data
Jul. 26, 2012 (JP) 2012-166140

(51) Int. Cl. H01R 13/629

(52) U.S. Cl. CPC H01R 13/629
USPC 439/162

(57) ABSTRACT

In a connector, interference portions for interfering with lances in accordance with an engagement state between lock holes of female terminals and the lances are provided in a male terminal housing to protrude toward a female terminal housing. The interference portions interfere with the lances to restrain male terminals from sliding against contact point members of the female terminals before the lock holes of the female terminals are engaged with the lances. The interference portions allow the male terminals to be connected to the female terminals without interfering with the lances after the lock holes of the female terminals are engaged with the lances.

### CROSS REFERENCE TO RELATED APPLICATIONS

This application is a continuation of PCT application No. PCT/JP2013/070076, which was filed on Jul. 24, 2013 based on Japanese Patent Application (No. 2012-166140) filed on Jul. 26, 2012, the contents of which are incorporated herein by reference.

### BACKGROUND OF THE INVENTION

1. Field of the Invention

The present invention relates to a fitting structure of a connector for electrically connecting a plurality of female terminals and a plurality of male terminals to each other.

2. Description of the Related Art

There has been known a connector in which a female terminal housing and a male terminal housing are formed integrally (for example, see JP-A-2010-40263). A plurality of female terminal housing chambers which house a plurality of female terminals respectively are formed in the female terminal housing. A plurality of male terminals which are connected to the plurality of female terminals are held in the male terminal housing. According to this connector, the plurality of male terminals are pressed into the male terminal housing to protrude into the female terminal housing chambers in the male terminal housing, and the plurality of female terminals are inserted into the female terminal housing chambers respectively. Thus, the female terminals and the male terminals are electrically connected to each other respectively. Particularly, according to the connector described in JP-A-2010-40263, each of the female terminals formed into a cylindrical shape contains an elastically deformable contact point member. A lock hole formed in one side surface of the cylinder is engaged with a lance which is formed as an elastic member in an inner wall of a corresponding one of the female terminal housing chambers, so that the female terminal can be prevented from slipping off. In addition, the connector is configured so that the male terminals are made to slide against the contact point members of the female terminals and electrically connected thereto in a fitting state between the two housings.

On the other hand, there is no suggestion in the connector described in JP-A-2010-40263 about how to reduce an insertion force with which the female terminals are inserted. That is, in addition to an elastic deformation force for bending the lances, an insertion force for making the male terminals slide and inserting the male terminals up to predetermined positions of the terminal housing chambers while bending the contact point members of the female terminals is required in order to insert the female terminals connected to wires into the predetermined positions. Since the insertion force is large, there is a fear that a worker performing a female terminal insertion work may end the terminal insertion work in spite of a half-insertion state to thereby cause an insertion failure of the female terminals.

To solve this problem, it can be considered that the male terminal housing and the female terminal housing are formed separately and connection between the female terminals and the male terminals is performed in two divided stages, i.e. a connection stage (first connection) in which the female terminals are inserted into the terminal housing chambers and engaged with the lances, and a connection stage (second connection) in which the male terminals are made to slide against the contact point members of the female terminals engaged with the lances. In this case, configuration may be made so that the male terminal housing and the female terminal housing can be fitted into each other respectively in a first fitting position (temporary fitting state) for performing the first connection and a second fitting position (regular fitting state) for performing the second connection.

However, even in the case of the configuration made thus, it is still necessary to surely and easily grasp that the female terminals are not in a half-insertion state when the male terminal housing and the female terminal housing are shifted from the temporary fitting state to the regular fitting state. For example, an initial load (reaction force) during the shift from the temporary fitting state to the regular fitting state may be hardly distinguished from resistance (feeling) during the half-insertion state of the female terminals. In this case, there is a fear that the male terminal housing and the female terminal housing may be shifted from the temporary fitting state to the regular fitting state by mistake in spite of the half-insertion state of the female terminals. At that time, there is also a possibility that an excessive pressing force is applied to the male terminals or the female terminals to cause damage to the male terminals or the female terminals.

### SUMMARY OF THE INVENTION

The invention has been accomplished based on the aforementioned circumstances. An object of the invention is to grasp a half-insertion state of female terminals into terminal housing chambers easily and surely while reducing a maximum load (load) during connection between male terminals and the female terminals.

In order to solve the problem, the invention consists in a connector having the following configuration. The connector includes: a female terminal housing in which a plurality of terminal housing chambers in which female terminals are inserted and housed respectively are formed; and a male terminal housing in which a plurality of male terminals connected to the female terminals are held, the female terminals having cylinder portions which contain elastically deformable contact point members, lock holes being formed in one side surfaces of the cylinder portions and being engaged with lances which are formed as elastic members in inner walls of the terminal housing chambers, the male terminals sliding against the contact point members of the female terminals and being connected thereto in accordance with fitting between the male terminal housing and the female terminal housing; wherein: interference portions for interfering with the lances in accordance with an engagement state between the lock holes of the female terminals and the lances are provided in the male terminal housing to protrude toward the female terminal housing; and the interference portions interfere with the lances to restrain the male terminals from sliding against the contact point members of the female terminals before engagement between the lock holes of the female terminals inserted into the terminal housing chambers and the lances, and allow the male terminals to slide against the contact point members of the female terminals without interfering with the lances after engagement between the lock holes of the female terminals inserted into the terminal housing chambers and the lances.

According to the connector having the configuration, the male terminals can be made to slide against the contact point members of the female terminals and be connected thereto in the state (regular insertion state) in which the lock holes of the female terminals inserted into the terminal housing chambers have been engaged with the lances. On the other hand, the interference portions can be made to interfere with the lances to prevent the male terminals from being connected with the contact point members of the female terminals in the state (half-insertion state) in which the lock holes of the female terminals inserted into the terminal housing chambers have not been engaged with the lances yet. Thus, it is possible to distinguish the half-insertion state from the regular insertion state easily so that it is possible to prevent a situation that the male terminals are forcibly made to slide against the contact point members of the female terminals and be connected thereto.

In this case, the configuration may be arranged as follow. That is, the lances are pressed by the female terminals to be elastically bent and deformed before the lances are engaged with the lock holes of the female terminals inserted into the terminal housing chambers. The lances are restored due to elastic bending deformation after the lances are engaged with the lock holes of the female terminals inserted into the terminal housing chambers. The interference portions interfere with the lances elastically bent and deformed, but do not interfere with the lances restored due to elastic bending deformation.

In addition, the configuration may be arranged so that: the male terminals are insert-molded in the male terminal housing; the male terminal housing and the female terminal housing have first engagement portions and second engagement portions which are engaged with each other in a first fitting position and a second fitting position during fitting so that the male terminal housing and the female terminal housing can be fitted into each other; the first fitting position is set as a position where the lock holes of the female terminals are engaged with the lances and in front of a position where the male terminals slide against the contact point members of the female terminals; the second fitting position is set as the position where the male terminals slide against the contact point members of the female terminals; the second engagement portions of the male terminal housing and the female terminal housing have abutting portions and abutted portions which abut against each other in the first fitting position, and abutment release portions which release abutment between the abutting portions and the abutted portions; and the abutment release portions elastically bend and deform the abutting portions with respect to the abutted portions to thereby release the abutment between the abutting portions and the abutted portions when the male terminal housing and the female terminal housing are moved from the first fitting position to the second fitting position.

According to the invention, it is possible to reduce a maximum load (load) during connection between male terminals and female terminals and it is also possible to grasp a half-insertion state of the female terminals into terminal housing chambers easily and surely.

The invention has been described briefly above. Further, when an undermentioned mode (hereinafter referred to as “embodiment”) for carrying out the invention is read through with reference to the accompanying drawings, details of the invention can be made further clear.

### BRIEF DESCRIPTION OF THE DRAWINGS

FIG. 1A to FIG. 1C are perspective views showing the overall configuration of a connector according to an embodiment of the invention, FIG. 1A being a view showing a state (pre-fitting state) in which a male terminal housing and a female terminal housing are separated from each other, FIG. 1B being a view showing a first fitting state (temporary fitting state), and FIG. 1C being a view showing a second fitting state (regular fitting state).

FIG. 2A to FIG. 2C are sectional views showing the overall configuration of the connector according to the embodiment of the invention, FIG. 2A being a view showing a half-insertion state, FIG. 2B being a view showing a state in which female terminals are inserted in the first fitting state, and FIG. 2C being a view showing a state in which the female terminals are inserted in the second fitting state.

FIG. 3 is a view of a female terminal housing side end surface of the connector.

FIG. 4A to FIG. 4C are views showing a cross section in a portion of an arrow A3 in FIG. 3 as seen from the direction of the arrow, FIG. 4A being a sectional view showing a state prior to the first fitting state, FIG. 4B being a sectional view showing a state when shift from the first fitting state to the second fitting is started, and FIG. 4C being a sectional view showing the second fitting state.

### DETAILED DESCRIPTION OF THE EXEMPLARY EMBODIMENTS

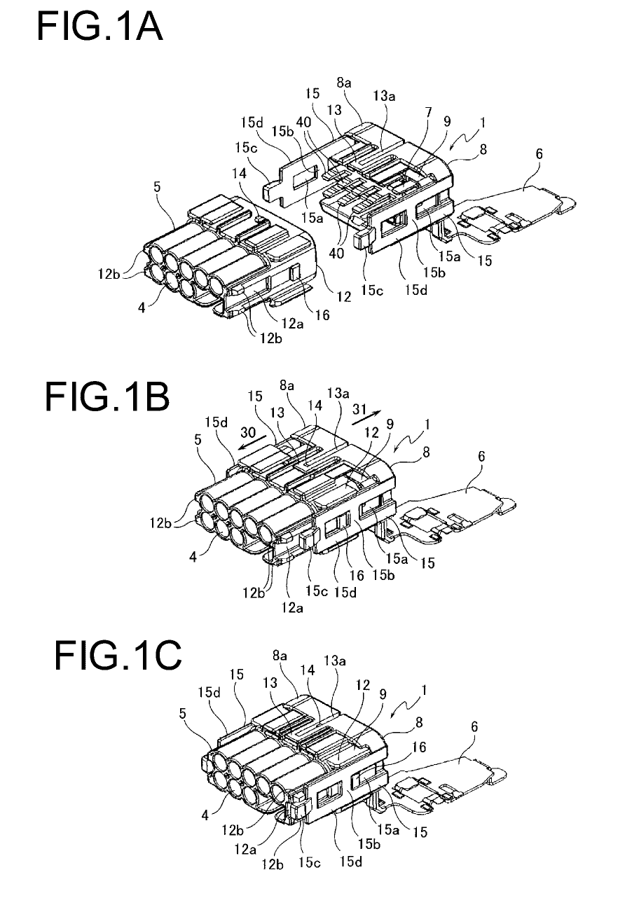

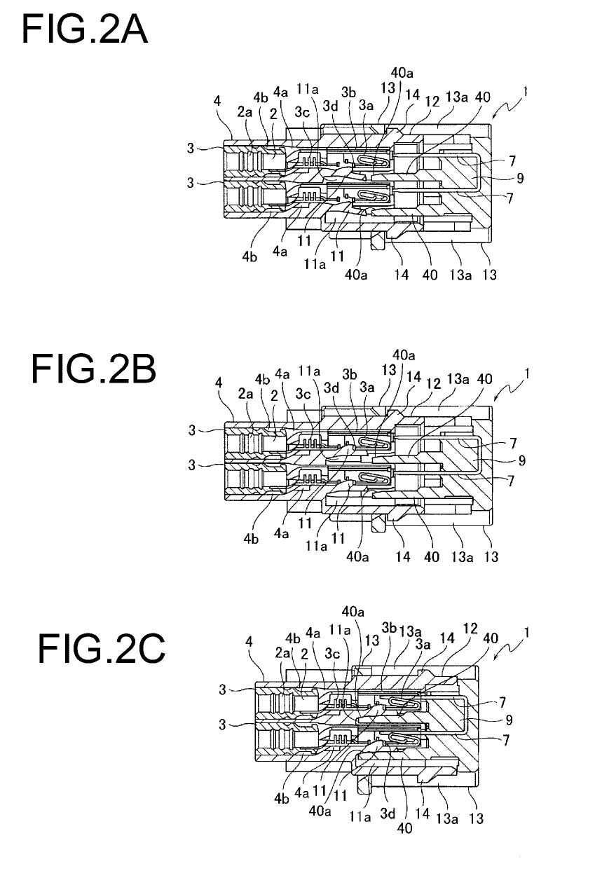

A connector according to the invention will be described below with reference to the accompanying drawings. FIG. 1A to FIG. 2C show the configuration of a connector according to an embodiment of the invention. FIG. 1A is a perspective view showing a state (pre-fitting state) in which a male terminal housing and a female terminal housing are separated from each other. FIG. 1B is a perspective view showing a first fitting state (temporary fitting state) which will be described later. FIG. 1C is a perspective view showing a second fitting state (regular fitting state) which will be described later. Incidentally, illustration of female terminals is omitted in FIG. 1A to FIG. 1C. In addition, FIG. 2A is a sectional view showing a half-insertion state which will be described later. FIG. 2B is a sectional view showing a state in which the female terminals are inserted in the first fitting state. FIG. 2C is a sectional view showing a state in which the female terminals are inserted in the second fitting state.

As shown in FIG. 1A to FIG. 2C, a connector 1 includes a female terminal housing 5 and a male terminal housing 8. A plurality of terminal housing chambers 4 are formed in the female terminal housing 5 and female terminals 3 are inserted and housed in the terminal housing chambers 4 respectively. A plurality of male terminals 7 connected to the female terminals 3 are held in the male terminal housing 8. In this case, each of the female terminals 3 has a cylinder portion in which an elastically deformable contact point member 3a is contained, and a lock hole 3d formed in one side surface of the cylinder portion is engaged with a lance 11 formed as an elastic member in an inner wall of a corresponding one of the terminal housing chambers 4. When the male terminal housing 8 and the female terminal housing 5 are fitted into each other, the male terminals 7 and the contact point members 3a of the female terminals 3 make slidable contact and connection with each other in the connector 1. Incidentally, the materials of the female terminal housing 5 and the male terminal housing 8 are not limited particularly, as long as they have elasticity. However, the case where both of the housings 5 and 8 are made of resin is assumed by way of example in the embodiment.

Each female terminal 3 is formed to include a contact point portion 3b, a solderless terminal portion 3c, and a ring packing 2a. The contact point portion 3b contains the elastically deformable contact point member 3a and is formed into a cylindrical shape. An electric wire 2 is crimped onto the solderless terminal portion 3c. The ring packing 2a is mounted on an outer circumference of an end portion of the electric wire 2. Each terminal housing chamber 4 of the female terminal housing 5 is formed to include a rectangular cylinder-shaped housing chamber (hereinafter referred to as rectangular cylinder portion) 4a in which the contact point portion 3b of the corresponding female terminal 3 is housed, and a cylinder-shaped housing chamber (hereinafter referred to as cylinder portion) 4b in which the solderless terminal portion 3c and the ring packing 2a of the electric wire 2 are housed. The rectangular cylinder portion 4a is positioned nearer to the side of the male terminal housing 8 than the cylinder portion 4b.

Each lance 11 is formed in an inner wall of a predetermined side (lower side in FIG. 2A to FIG. 2C) of the rectangular cylinder portion 4a of the corresponding terminal housing chamber 4. In this case, the lance 11 is molded integrally into a cantilever shape and from the same resin as that for the female terminal housing 5, so as to extend from the cylinder portion 4b of the terminal housing chamber 4 in which the electric wire 2 is housed to the rectangular cylinder portion 4a where the female terminal 3 is housed. Incidentally, the lances 11 may be formed in accordance with the number of the female terminals 3 so that one lance 11 can be formed in every terminal housing chamber 4 and the same number of lances 11 as the female terminals 3 can be formed in the female terminal housing 5.

In addition, the lance 11 pressed by the female terminal 3 is elastically bent and deformed before the lance 11 is engaged with the lock hole 3d of the female terminal 3 which has been inserted into the terminal housing chamber 4 (the state shown in FIG. 2A. Hereinafter, this state will be referred to as half-insertion state.). The lance 11 is restored due to elastic bending deformation after the lance 11 is engaged with the lock hole 3d of the female terminal 3 which has been inserted into the terminal housing chamber 4 (the state shown in FIG. 2B. Hereinafter, this state will be referred to as regular insertion state.). Specifically, in the half-insertion state, the lance 11 is elastically bent and deformed (downward in FIG. 2A) so as to leave the rectangular portion 4a of the terminal housing chamber 4. In the regular insertion state, the lance 11 is restored due to elastic bending deformation (upward in FIG. 2B) so as to enter the rectangular portion 4a of the terminal housing terminal 4 in the position of the lock hole 3d of the female terminal 3. Thus, the lance 11 is engaged with the lock hole 3d of the female terminal 3. In this manner, the female terminal 3 is locked to the lance 11 and therefore prevented from slipping off in the regular insertion state. Incidentally, a cylinder-shaped female hood 12 is provided in the female terminal housing 5 to stick out from outer circumferential surfaces of the rectangular portions 4a of the terminal housing chambers 4.

A plurality of male terminals 7 are insert-molded and held in the male terminal housing 8 so that the male terminals 7 can be inserted into the female terminals 3 and connected thereto. Each male terminal 7 is made of a plate-like conductor. The male terminal 7 is formed so that its front end can enter the rectangular portion 4a of the terminal housing chamber 4 of the female terminal housing 5 to make slidable connection with the contact point member 3a of the female terminal 3. In addition, the plurality of male terminals 7 are connected to a bus bar 6 to be fixedly connected to an external conductor (ground conductor by way of example) through the bus bar 6. A body portion 9 is formed in a base portion 8a of the male terminal housing 8 so that the body portion 9 can be covered with the female hood 12 of the female terminal housing 5. Incidentally, a ring-like sealing member (for example, a water-proof packing etc.) is mounted between the body portion 9 and the female hood 12 so that water can be prevented from intruding into the connection portions between the male terminals 7 and the female terminals 3. Thus, the connector 1 can have a water-proof structure.

As described above, the connector 1 has a configuration in which the male terminal housing 8 and the female terminal housing 5 are fitted into each other to make the male terminals 7 slide against the contact point members 3a of the female terminals 3 to thereby connect the male terminals 7 to the contact point members 3a of the female terminals 3. In this case, the male terminal housing 8 and the female terminal housing 5 have first engagement portions and second engagement portions which are engaged with each other in a first fitting position and a second fitting position during fitting. Therefore, the male terminal housing 8 and the female terminal housing 5 are fitted into each other in two stages. The first fitting position is set as a position where the lock holes 3d of the female terminals 3 are engaged with the lances 11 as shown in FIG. 1B and FIG. 2B. The first fitting position is located in front of a position where the male terminals 7 slide against the contact point members 3a of the female terminals 3. On the other hand, the second fitting position is set as the position where the male terminals 7 slide against the contact point members 3a of the female terminals 3, as shown in FIG. 1C and FIG. 2C. In the following description, the state in which the male terminal housing 8 and the female terminal housing 5 are in the first fitting position is referred to as first fitting state, and the state in which the male terminal housing 8 and the female terminal housing 5 are in the second fitting position is referred to as second fitting state. Incidentally, in the first fitting state and the second fitting state, the lock holes 3d of the female terminals 3 and the lances 11 are engaged with each other. Accordingly, each of the first fitting state and the second fitting state corresponds to the regular insertion state. In this manner, the connector 1 has a configuration in which when the male terminal housing 8 and the female terminal housing 5 are shifted from the first fitting state to the second fitting state (moved from the first fitting position to the second fitting position), the male terminals 7 slide against the contact point members 3a of the female terminals 3.

In the embodiment, interference portions (hereinafter referred to as half-insertion detection pins) 40 for interfering with the lances 11 in accordance with the engagement state (the half-insertion state and the regular insertion state) between the lock holes 3d of the female terminals 3 and the lances 11 are provided in the male terminal housing 8 to protrude toward the female terminal housing 5. FIG. 1A and FIG. 2A to FIG. 2C show the configuration of each interference portion 40 which is shaped like a plate to extend toward the lance 11 by way of example. Incidentally, the half-insertion detection pins 40 may be provided in the male terminal housing 8 correspondingly to the number of lances 11, in another expression, correspondingly to the number of the female terminals 3 inserted into the terminal housing chambers 4 (in other words, the number of the male terminals 7 mounted in the male terminal housing 8) so that the half-insertion detection pins 40 are equal in number to the lances 11, the female terminals 3 and the male terminals 7. As an example, eight half-insertion detection pins 40 are provided in the male terminal housing 8 correspondingly to eight female terminals 3 inserted into the terminal housing chambers 4 in the configuration shown in FIG. 1A and FIG. 2A to FIG. 2C.

The half-insertion detection pins 40 interfere with the lances 11 to restrain the male terminals 7 from sliding against the contact point members 3a of the female terminals 3 before the lock holes 3d of the female terminals 3 which have been inserted into the terminal housing chambers 4 are engaged with the lances 11, i.e. in the half-insertion state. On the other hand, the half-insertion detection pins 40 allow the male terminals 7 to slide against the contact point members 3a of the female terminals 3 without interfering with the lances 11 after the lock holes 3d of the female terminals 3 which have been inserted into the terminal housing chambers 4 are engaged with the lances 11, i.e. in the regular insertion state. That is, the half-insertion detection pins 40 interfere with the lances 11 elastically bent and deformed in the half-insertion state but do not interfere with the lances 11 restored due to elastic bending deformation in the regular insertion state.

Here, in the case where the engagement state between the lances 11 and the lock holes 3d of the female terminals 3 is the half-insertion state as shown in FIG. 2A before the male terminal housing 8 and the female terminal housing 5 are brought into the first insertion state, the lances 11 are pressed by the female terminals 3 to be elastically bent and deformed to leave the rectangular portions 4a of the terminal housing chambers 4. In the state where the lances 11 are thus elastically bent and deformed, the lances 11 close gap portions 11a of the cantilever portions. The gap portions 11a are gaps serving as advancing paths of the half-insertion detection pins 40 when the male terminals 7 are moved to the position (the second fitting position) where the male terminals 7 slide against the contact point members 3a of the female terminals 3. That is, the lances 11 which have been elastically bent and deformed close the advancing paths of the half-insertion detection pins 40. Accordingly, even when the male terminal housing 8 and the female terminal housing 5 are intended to be shifted from the first fitting state to the second fitting state in order to make the female terminals 3 slide against the contact point members 3a, the half-insertion detection pins 40 interfere with the lances 11 so that the half-insertion detection pins 40 cannot be advanced into the gap portions 11a. That is, in the half-insertion state, the male terminal housing 8 and the female terminal housing 5 cannot be shifted from the first fitting state to the second fitting state and the male terminals 7 cannot be therefore made to slide against the contact point members 3a of the female terminals 3.

On the other hand, in the first fitting state (corresponding to the regular fitting state), the half-insertion detection pins 40 and the lances 11 do not interfere with each other but their front end portions are opposed to each other in a non-contact state (the state shown in FIG. 2B). In addition, the half-insertion detection pins 40 are configured to protrude more toward the female terminal housing 5 (straightly, toward the lances 11) than the male terminals 7. The male terminals 7 do not slide against the contact point members 3a of the female terminals 3 in the first fitting state. When the male terminal housing 8 and the female terminal housing 5 are shifted from the first fitting state to the second fitting state in order to make the male terminals 7 slide against the contact point members 3a of the female terminals 3, the half-insertion detection pins 40 enter the gap portions 11a of the lances 11 (the state shown in FIG. 2C). Incidentally, the half-insertion detection pins 40 may be configured to have their front end butt surfaces (front end upper surfaces in FIG. 2A to FIG. 2C) 40a sloped to descend toward the lances 11 so that the half-insertion detection pins 40 can enter the gap portions 11a smoothly when the half-insertion detection pins 40 butt against the lances 11 during the shift from the first fitting state to the second fitting state. When the half-insertion detection pins 40 enter the gap portions 11a on the back sides of the lances 11 in this manner, the front ends of the male terminals 7 go into the rectangular portions 4a of the terminal housing chambers 4 to be positioned in the second fitting position so that the male terminals 7 can slide against the contact point members 3a of the female terminals 3. That is, in the regular fitting state, the male terminal housing 8 and the female terminal housing 5 can be shifted from the first fitting state to the second fitting state so that the male terminals 7 can slide against the contact point members 3a of the female terminals 3.

Thus, the half-insertion detection pins 40 have a function of detecting (straightly, a function of making a worker recognize) whether the engagement state between the lock holes 3d of the female terminals 3 and the lances 11 is the half-insertion state or the regular insertion state, and hence a function of detecting whether the male terminal housing 8 and the female terminal housing 5 can be shifted from the first fitting state to the second fitting state to thereby make the male terminals 7 slide against the contact point members 3a of the female terminals 3 or not.

Next, the configuration of the first engagement portions and the second engagement portions engaged with each other in the first fitting position and the second fitting position will be described. The first engagement portions are configured to include temporary lock arms 13 provided in the male terminal housing 8, and temporary lock protrusions 14 provided in the female terminal housing 5. The temporary lock arms 13 each shaped like a plate are extended from the outer circumferential surface (upper and lower surfaces in FIG. 1A to FIG. 2C) of the base portion 8a of the male terminal housing 8 toward the outer circumferential surface of the female hood 12 of the female terminal housing 5. Each of the temporary lock arms 13 has a temporary lock groove 13a which is formed to extend in the fitting direction between the male terminal housing 8 and the female terminal housing 5. On the other hand, the temporary lock protrusions 14 are provided to protrude outward from the outer circumferential surface (upper and lower surfaces in FIG. 1A to FIG. 2C) of the female hood 12 of the female terminal housing 5 correspondingly to the temporary lock grooves 13a. Each of the temporary lock protrusions 14 is formed to be sloped so that a front end butt surface (front end lower surface or front end upper surface in FIG. 2A to FIG. 2C) of the corresponding temporary lock arm 13 and a butt portion (upper end portion or lower end portion in FIG. 2A to FIG. 2C) of the temporary lock protrusion 14 can be parallel with each other with a result that the temporary lock arm 13 can butt against the temporary lock protrusion 14 to ride on the temporary lock protrusion 14 easily when fitting between the male terminal housing 8 and the female terminal housing 5 is started. Further, when the fitting between the male terminal housing 8 and the female terminal housing 5 goes forward, the temporary lock protrusions 14 fall into the temporary lock grooves 13a of the temporary lock arms 13 so as to be located in the first fitting position. The female terminals 3 are inserted into the terminal housing chambers 4 and the engagement holes 3d of the female terminals 3 are locked to the lances 11 so that the female terminals 3 can be prevented from slipping off (the state shown in FIG. 2B). Thus, the male terminal housing 8 and the female terminal housing 5 are brought into the first fitting state. In order to release the male terminal housing 8 and the female terminal housing 5 from fitting to each other in the first fitting state achieved in this manner, the temporary lock arms 13 are bent to release the temporary lock grooves 13a and the temporary lock protrusions 14 from locking with each other. This can be done by a release force which is simply small enough to bend the plate-like temporary lock arms 13.

On the other hand, the second engagement portions are configured to include a pair of regular lock arms 15 provided in the male terminal housing 8 and a pair of regular lock protrusions 16 provided in the female terminal housing 5. The regular lock arms 15 each shaped like a plate are extended from the outer circumferential surface (side surfaces along arrows 30 and 31 in FIG. 1A to FIG. 1C) of the base portion 8a of the male terminal housing 8 toward the outer circumferential surface of the female hood 12 of the female terminal housing 5. Each of the regular lock arms 15 has a regular lock groove 15a which is formed to extend in the fitting direction between the male terminal housing 8 and the female terminal housing 5. On the other hand, the regular lock protrusions 16 are provided to protrude outward from the outer circumferential surface (side surfaces along the arrows 30 and 31 in FIG. 1A to FIG. 1C) of the female hood 12 of the female terminal housing 5 correspondingly to the regular lock grooves 15a. The regular lock protrusions 16 are formed to be sloped so that butt portions of front ends of the regular lock arms 15 and butt portions of the temporary lock protrusions 14 can be parallel with each other with a result that the regular lock arms 15 can butt against the regular lock protrusions 16 to ride on the regular lock protrusions 16 easily when the male terminal housing 8 and the female terminal housing 5 are moved from the first fitting position to the second fitting position.

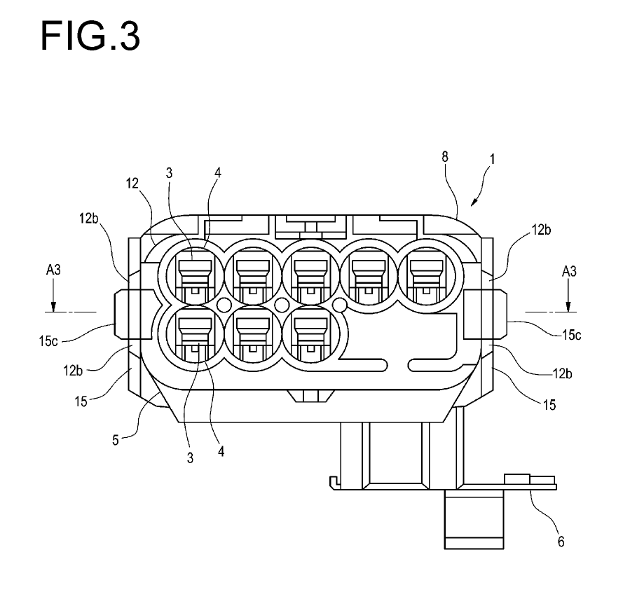

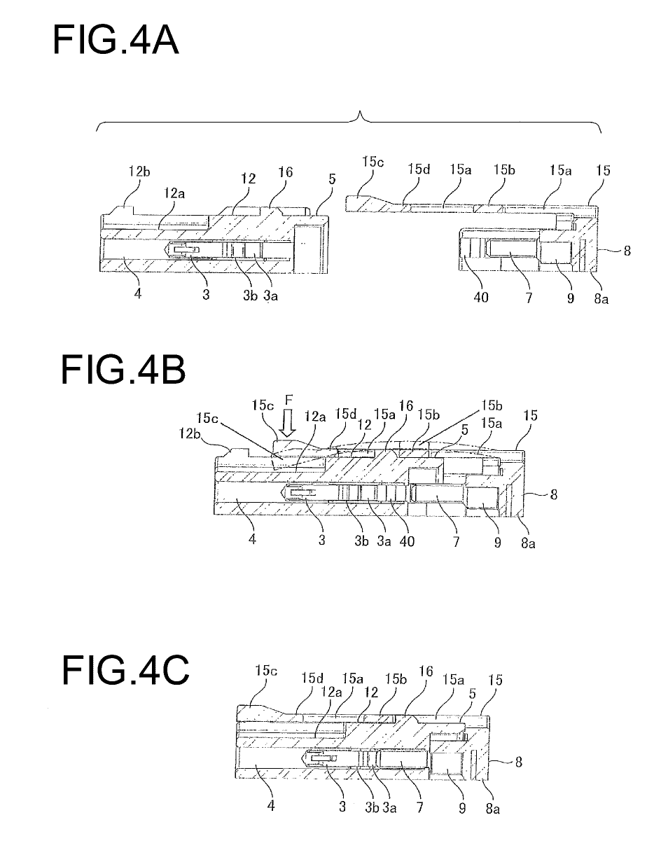

In addition, in the embodiment, the second engagement portions have abutting portions and abutted portions which abut against each other in the first fitting position, and abutment release portions which release the abutment between the abutting portions and the abutted portions. The abutment release portions elastically bend and deform the abutting portions with respect to the abutted portions to release the abutment between the abutting portions and the abutted portions when the male terminal housing 8 and the female terminal housing 5 are moved from the first fitting position to the second fitting position. FIG. 3 and FIG. 4A to FIG. 4C show the configuration of each abutting portion, each abutted portion and each abutment release portion. FIG. 3 is a view of an end surface of the female terminal housing 5 side of the connector 1. FIG. 4A to FIG. 4C shows cross-sectional views of the abutting portion, the abutted portion and the abutment release portion in a portion of an arrow A3 in FIG. 3, as seen from the direction of the arrow A3. FIG. 4A is a sectional view showing a state prior to the first fitting state. FIG. 4B is a sectional view showing a state when the shift from the first fitting state to the second fitting state is started. FIG. 4C is a sectional view showing the second fitting state.

In this case, arm lock portions 15b which are laid across the regular lock grooves 15a to intersect with the regular lock grooves 15a are provided as the abutting portions in the regular lock arms 15. The arm lock portions 15b abut against the regular lock protrusions 16 on the side of the moving direction (the right side in FIG. 4B) from the first fitting position to the second fitting position, in the first fitting position. In other words, the regular lock protrusions 16 are provided in the female hood 12 of the female terminal housing 5 and in positions where the regular lock protrusions 16 can precisely butt against the arm lock portions 15b in the first fitting position. Thus, the regular lock protrusions 16 serve not only as the second engagement portions but also as the abutted portions.

In addition, release protrusions 15c are provided as the abutment release portions in arm front ends of the regular lock arms 15. The release protrusions 15c are extended from front ends of body portions 15d of the regular lock arms 15 further toward the outer circumferential surface of the female hood 12 of the female terminal housing 5. In this case, each of the release protrusions 15c is configured to have a width (for example, a dimension along an up/down direction in FIG. 1A to FIG. 1C) smaller (narrower) than the width of the body portion 15d. In addition, each of the release protrusions 15c is bulged outward (upward in FIG. 4A to FIG. 4C) so as to have a larger thickness than the thickness (plate thickness) of the body portion 15d. However, the inner side (lower side in FIG. 4A to FIG. 4C) of the release protrusion 15c is continued to be leveled with the body portion 15d so as to form a flat shape along the outer circumferential surface of the female terminal housing 5.

On the other hand, release recesses 12a are formed as the abutment release portions in the female terminal housing 5. The release recesses 12a are formed so as to be recessed in the outer circumferential surface (the side surfaces along the arrows 30 and 31 in FIG. 1A to FIG. 1C) of the female hood 12 correspondingly to the release protrusions 15c. In this case, the release recesses 12a serve as depressions (undercut portions) which can receive the release protrusions 15c pressed toward the release recesses 12a when the release protrusions 15c are pressed in the first fitting state. Accordingly, the size (the length corresponding to a dimension in the left/right direction in FIG. 4A to FIG. 4C and the depth corresponding to a dimension in the up/down direction in FIG. 4A to FIG. 4C) of each of the release recesses 12a may be set so that the release recess 12a can receive the release protrusion 15c pressed toward the release recess 12a. However, it is not necessary to entirely receive the release protrusions 15c in the release recesses 12a. The depth (corresponding to the dimension in the up/down direction in FIG. 4A to FIG. 4C) of each of the release recesses 12a may be set to be larger than a protruding height of the corresponding regular lock protrusion 16 from the outer circumferential surface of the female hood 12 so that, for example, the arm lock portions 15b can be elastically bent and deformed with respect to the regular lock protrusions 16 to release the abutment between the arm lock portions 15b and the regular lock protrusions 16 when the release protrusions 15c are pressed toward the release recesses 12a and received in the release recesses 12a, as will be described later. Incidentally, pairs of protrusion supporting portions 12b are provided in the female terminal housing 5 to protrude from lengthwise end portions (left end portions in FIG. 4A to FIG. 4C) of the release recesses 12a so that each pair of the protrusion supporting portions 12b can support the corresponding release protrusion 15c to put the release protrusion 15c therebetween in the second fitting state.

The release protrusions 15c and the release recesses 12a are provided as the abutment release portions. Therefore, when the shift from the first fitting state to the second fitting state is started, the arm lock portions 15b can be elastically bent and deformed with respect to the regular lock protrusions 16 to thereby release the abutment between the arm lock portions 15b and the regular lock protrusions 16. That is, in the case where the male terminal housing 8 and the female terminal housing 5 are in the first fitting state, the regular lock arms 15 are in a state (the state shown by a solid line in FIG. 4B) in which the arm lock portions 15b abut against the regular lock protrusions 16 while the release protrusions 15c are opposed to the release recesses 12a. When the release protrusions 15c are pressed toward the release recesses 12a and received in the release recesses 12a in the first fitting state, that is, when a pressing force toward the release recesses 12a (a force indicated by an arrow F in FIG. 4B) is applied to the release protrusions 15c, the regular lock arms 15 are brought into a state (state indicated by a chain line in FIG. 4B) in which the regular lock arms 15 are elastically bent and deformed to bulge outward (upward in FIG. 4B). For example, when the pair of release protrusions 15c are pinched to be nipped, the pressing force F toward the release recesses 12a can be applied. In this manner, the arm lock portions 15b can be separated from the regular lock protrusions 16 so that the abutment between the arm lock portions 15b and the regular lock protrusions 16 can be released.

When the shift from the first fitting state to the second fitting state is started in the state in which the regular lock arms 15 are thus elastically bent and deformed, the abutment between the arm lock portions 15b and the regular lock protrusions 16 can be released. Accordingly, the arm lock portions 15b can climb over the regular lock protrusions 16 smoothly. When the pressing force F on the release protrusions 15c is released after the arm lock portions 15b have climbed over the regular lock protrusions 16, the regular lock arms 15 are restored due to elastic bending deformation so that the regular lock protrusions 16 can be locked inside the regular lock grooves 15a. At that time, the arm lock portions 15b abut against the regular lock protrusions 16 on an opposite side (the left side in FIG. 4C) to the movement direction from the first fitting position to the second fitting position. In addition, each of the release protrusions 15c is supported to be put between a corresponding pair of the protrusion supporting portions 12b. Thus, the male terminal housing 8 and the female terminal housing 5 can be brought into the second fitting state (the state shown in FIG. 1C and FIG. 4C).

Thus, during the shift from the first fitting state to the second fitting state, the pressing force F toward the release recesses 12a is applied to the release protrusions 15c so that the abutment between the arm lock portions 15b and the regular lock protrusions 16 can be released due to the elastic bending deformation of the regular lock arms 15. Accordingly, the load (initial load) applied during the shift can be reduced. As described above, the shift from the first fitting state to the second fitting state cannot be performed in the half-insertion state. Resistance is generated at that time due to an interference load applied between the half-insertion detection pins 40 and the lances 11. The resistance is remarkably larger than the initial load. Accordingly, a worker can distinguish difference between the both easily and accurately.

In addition, as described above, the male terminal housing 8 and the female terminal housing 5 are fitted into each other in two stages (the first fitting state and the second fitting state) for connecting the male terminals 7 and the female terminals 3 to each other in the embodiment. At that time, the first fitting position is set as a position where the lock holes 3d of the female terminals 3 are engaged with the lances 11 and in front of a position where the male terminals 7 slide against the contact point members 3a of the female terminals 3. Since the first fitting state is a temporary fitting state, the first fitting state can be established satisfactorily if the female terminals 3 apply a load corresponding to an insertion force for elastically bending and deforming the lances 11. In addition, in the first fitting state, the regular lock arms 15 abut against the regular lock protrusions 16 and the temporary lock grooves 13a of the temporary lock arms 13 and the temporary lock protrusions 14 are locked to each other. Accordingly, the temporary fitting state can be kept even when a force is applied in the direction of either of the arrows 30 and 31 shown in FIG. 1B.

In order to shift the state from the first fitting state to the second fitting state, the pressing force F toward the release recesses 12a is applied to the release protrusions 15c to elastically bend and deform the regular lock arms 15 to release the abutment between the arm lock portions 15b and the regular lock protrusions 16. In the meantime, the release protrusions 15c are moved to climb over the lock protrusions 16 by a force applied in the direction of the arrow 30 in FIG. 1B. When the male terminal housing 8 and the female terminal housing 5 are directly moved up to the second fitting position and the pressing force F on the release protrusions 15c is released to fit these housings 5 and 8 into each other, the male terminals 7 slide to be inserted up to predetermined positions while bending the contact point members 3a of the female terminals 3. Thus, the two terminals are connected to each other to achieve the second fitting state. The second fitting state is a regular fitting state. The load applied to establish the regular fitting state only requires a force for bending the contact point members 3a of the female terminals 3 and sliding friction between the female terminals 7 and the contact point members 3a. The load for elastically bending and deforming the lances 11 is not applied.

Accordingly, the load applied for connecting the male terminals 7 and the female terminals 3 to each other can be dispersed to the load for achieving the first fitting state and the load for achieving the second fitting state so that the maximum load in the connection can be reduced.

As described above, according to the connector 1 according to the embodiment, the maximum load for making connection between the male terminals 7 and the female terminals 3 to each other can be reduced and the half-insertion state of the female terminals 3 into the terminal housing chambers 4 can be grasped easily and surely. That is, the initial load (reaction force) during the shift from the first fitting state (temporary fitting state) to the second fitting state (regular fitting state) can be distinguished easily from the resistance (feeling) during the half-insertion state of the female terminals. Therefore, it is possible to surely prevent a work mistake that, for example, the male terminal housing 8 and the male terminal housing 5 are shifted from the temporary fitting state to the regular fitting state by mistake although the female terminals 3 are in the half-insertion state. As a result, it is also possible to avoid a problem that an excessive pressing force is applied to the male terminals 7 or the female terminals 3 to thereby cause damage to the male terminals 7 or the female terminals 3.

The present invention is not limited to the aforementioned embodiment but may be modified or improved desirably and suitably. In addition, the materials, the shapes, the dimensions, the numerical values, the forms, the numbers, the locations etc. of the constituent elements in the aforementioned embodiment are not limited but may be set desirably as long as they can achieve the invention.

Although the invention has been described in detail with reference to a specific embodiment, it is apparent to those skilled in the art that various changes or modifications may be made without departing from the spirit and scope of the invention.

According to the invention, it is possible to reduce a maximum load (load) during connection between male terminals and female terminals and it is also possible to grasp a half-insertion state of the female terminals into terminal housing chambers easily and surely.

The invention having such an effect is useful in the connector field.

Here, the aforementioned characteristics of the embodiment of the connector according to the invention are summarized briefly in the following paragraphs [1] to [3].

[1] A connector (1) including: a female terminal housing (5) including a plurality of terminal housing chambers (4) in which female terminals (3) are inserted and housed respectively; and a male terminal housing (8) holding a plurality of male terminals (7) connected to the female terminals (3), wherein the female terminals (3) having cylinder portions which have elastically deformable contact point members (3a), lock holes (3d) being formed in one side surfaces of the cylinder portions and being engaged with lances (11) which are formed as elastic members in inner walls of the terminal housing chambers (4), wherein the male terminals (7) slide against the contact point members (3a) of the female terminals (3) to contact the contact point members respectively in accordance with fitting between the male terminal housing (8) and the female terminal housing (5); wherein interference portions (40) for interfering with the lances (11) in accordance with an engagement state between the lock holes (3d) of the female terminals (3) and the lances (11) are provided in the male terminal housing (8) to protrude toward the female terminal housing (5); and wherein the interference portions (40) interfere with the lances (11) to restrain the male terminals (7) from sliding against the contact point members (3a) of the female terminals (3) before engagement between the lock holes (3d) of the female terminals (3) inserted into the terminal housing chambers (4) and the lances (11), and allow the male terminals (7) to slide against the contact point members (3a) of the female terminals (3) without interfering with the lances (11) after completion of the engagement between the lock holes (3d) of the female terminals (3) inserted into the terminal housing chambers (4) and the lances (11).
[2] The connector (1) according to the paragraph [1], wherein the lances (11) are pressed by the female terminals (3) to be elastically bent and deformed before the lances (11) are engaged with the lock holes (3d) of the female terminals (3) inserted into the terminal housing chambers (4), and the lances (11) are restored due to elastic bending deformation of the lances (11) after the lances (11) are engaged with the lock holes (3d) of the female terminals (3) inserted into the terminal housing chambers (4); and

wherein the interference portions (40) interfere with the lances (11) elastically bent and deformed, but do not interfere with the lances (11) restored due to the elastic bending deformation.

[3] The connector according to the paragraph [1] or [2], wherein the male terminals (7) are insert-molded in the male terminal housing (8); wherein the male terminal housing (8) and the female terminal housing (5) have first engagement portions and second engagement portions which are engaged with each other in a first fitting position and a second fitting position during fitting of the male terminal housing (8) and the female terminal housing (5) so that the male terminal housing (8) and the female terminal housing (5) can be fitted into each other;

wherein the first fitting position is set as a position where the lock holes (3d) of the female terminals (3) are engaged with the lances (11) and in front of a position where the male terminals (7) slide against the contact point members (3a) of the female terminals (3);

wherein the second fitting position is set as the position where the male terminals (7) slide against the contact point members (3d) of the female terminals (3);

wherein the second engagement portions of the male terminal housing (8) and the female terminal housing (5) have abutting portions (15b) and abutted portions (16) which abut against each other in the first fitting position, and abutment release portions (15c) which release abutment between the abutting portions (15b) and the abutted portions (16); and

wherein the abutment release portions (15c) elastically bend and deform the abutting portions (15b) with respect to the abutted portions (16) to thereby release the abutment between the abutting portions (15b) and the abutted portions (16) when the male terminal housing (8) and the female terminal housing (5) are moved from the first fitting position to the second fitting position.

What is claimed is:

1. A connector comprising:
a female terminal housing including a plurality of terminal housing chambers in which female terminals are inserted and housed respectively; and
a male terminal housing holding a plurality of male terminals connected to the female terminals,
wherein the female terminals having cylinder portions which have elastically deformable contact point members, lock holes being formed in one side surfaces of the cylinder portions and being engaged with lances which are formed as elastic members in inner walls of the terminal housing chambers;
wherein the male terminals slide against the contact point members of the female terminals to contact the contact point members respectively in accordance with fitting between the male terminal housing and the female terminal housing;
wherein interference portions for interfering with the lances in accordance with an engagement state between the lock holes of the female terminals and the lances are provided in the male terminal housing to protrude toward the female terminal housing;
wherein the interference portions interfere with the lances to restrain the male terminals from sliding against the contact point members of the female terminals before engagement between the lock holes of the female terminals inserted into the terminal housing chambers and the lances, and allow the male terminals to slide against the contact point members of the female terminals without interfering with the lances after completion of the engagement between the lock holes of the female terminals inserted into the terminal housing chambers and the lances
wherein the male terminals are insert-molded in the male terminal housing;
wherein the male terminal housing and the female terminal housing have first engagement portions and second engagement portions which are engaged with each other in a first fitting position and a second fitting position during the fitting between the male terminal housing and the female terminal housing so that the male terminal housing and the female terminal housing can be fitted into each other;
wherein the first fitting position is set as a position where the lock holes of the female terminals are engaged with the lances and in front of a position where the male terminals slide against the contact point members of the female terminals;
wherein the second fitting position is set as the position where the male terminals slide against the contact point members of the female terminals;
wherein the second engagement portions of the male terminal housing and the female terminal housing have abutting portions and abutted portions which abut against each other in the first fitting position to restrict movement of the female terminal housing in a fitting direction for the fitting, and abutment release portions which release abutment between the abutting portions and the abutted portions; and
wherein the abutment release portions elastically bend and deform the abutting portions with respect to the abutted portions to thereby release the abutment between the abutting portions and the abutted portions when the male terminal housing and the female terminal housing are moved from the first fitting position to the second fitting position.

2. The connector according to claim 1, wherein the lances are pressed by the female terminals to be elastically bent and deformed before the lances are engaged with the lock holes of the female terminals inserted into the terminal housing chambers, and the lances are restored due to elastic bending deformation of the lances after the lances are engaged with the lock holes of the female terminals inserted into the terminal housing chambers; and
wherein the interference portions interfere with the lances elastically bent and deformed, but do not interfere with the lances restored due to the elastic bending deformation.
